(19) United States
(12) Patent Application Publication
(10) Pub. No.: US 2012/0032897 A1
(43) Pub. Date: Feb. 9, 2012

(54) PORTABLE ELECTRONIC DEVICE AND METHOD OF DETECTING CONTACT UTILIZED THEREBY

(75) Inventors: KUN-YI CHEN, Tu-Cheng (TW); WEN-CHIEH KUO, Tu-Cheng (TW); YU-CHUN CHEN, Tu-Cheng (TW); REN-HONG WANG, Tu-Cheng (TW)

(73) Assignee: Chi Mei Communication Systems, Inc., Tu-Cheng City (TW)

(21) Appl. No.: 12/947,831

(22) Filed: Nov. 17, 2010

(30) Foreign Application Priority Data
Aug. 9, 2010 (TW) 99126531

(51) Int. Cl. G06F 3/041

(52) U.S. Cl. 345/173

(57) ABSTRACT

In a method of detecting input for a portable electronic device, when a virtual keyboard is displayed on a display of a touch panel, an accelerometer detects orientation of the portable electronic device to adjust a contact area of each key of the virtual keyboard. The adjusted display of each key provides a suitable contact area on the virtual keyboard according to the detected orientation of the portable electronic device.

### BACKGROUND

1. Technical Field

Embodiments of the present disclosure relate to touch panel devices, and more particularly to a method of detecting contact of a virtual keyboard of a portable electronic device and the portable electronic device utilizing the same.

2. Description of Related Art

A common input method for a portable electronic device having a touch screen is to provide a virtual keyboard on the touch screen. Often, the virtual keyboard is set as a fixed type, for example, each key is displayed on the touch screen at a fixed position. However, input position to the virtual keyboard can vary with user, which can cause errors due to the changing viewing angles.

### BRIEF DESCRIPTION OF THE DRAWINGS

FIG. 1 is a block diagram of one embodiment of a portable electronic device.

FIG. 2 is a schematic diagram of one embodiment of an accelerometer of the portable electronic device of FIG. 1 positioned on three coordinate axes.

FIG. 3 is a schematic diagram of one embodiment of a virtual keyboard of the portable electronic device of FIG. 1.

FIG. 4 is a schematic diagram of one embodiment of parts of keys of the virtual keyboard of the portable electronic device of FIG. 3.

FIG. 5 is a flowchart of one embodiment of a method of detecting contact for a portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

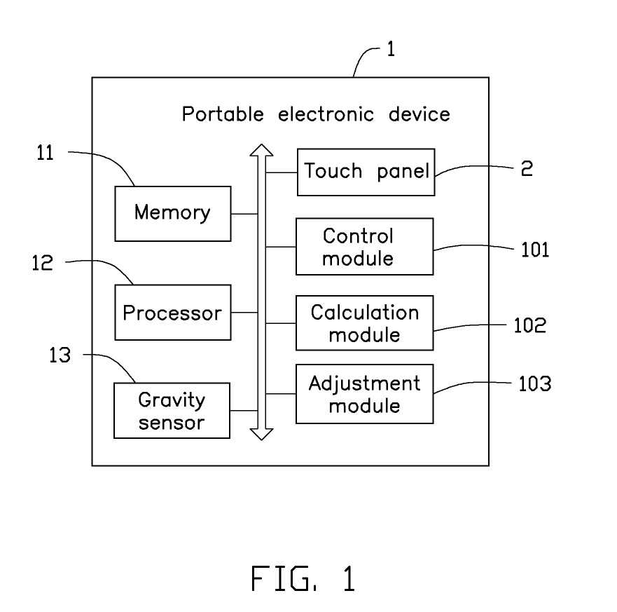

FIG. 1 is a block diagram of one embodiment of a portable electronic device 1. Depending on the embodiment, the portable electronic device 1 may be a mobile phone, a personal digital assistant (PDA), a multimedia player, a handheld game console, a digital camera (DC), a handheld computer, or a tablet computer. The portable electronic device 1 includes a touch panel 2, a memory 11, at least one processor 12, an accelerometer 13 and one or more programs including a control module 101, a calculation module 102 and an adjustment module 103.

The portable electronic device 1 is generally controlled and coordinated by an operating system software, such as UNIX, LINUX, WINDOWS, MAC OS X, an embedded operating system, or any other compatible operating systems. In other embodiments, the portable electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

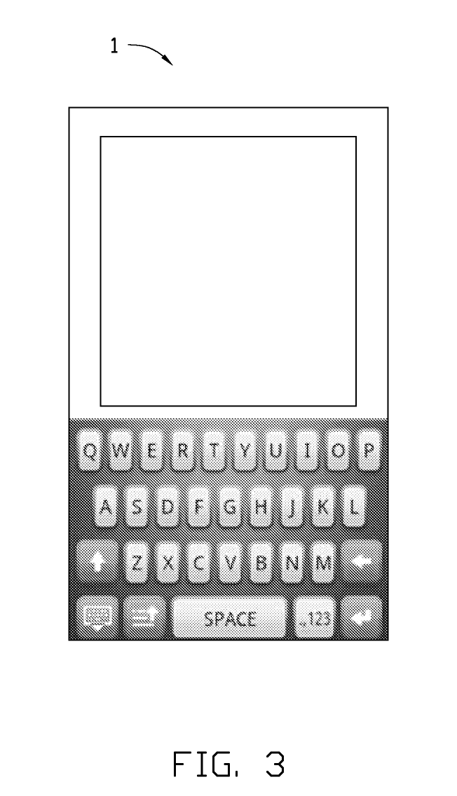

The touch panel 2 is operable to receive a input based on at least one finger contact or a stylus contact on the touch panel 2 and display information of the portable electronic device 1. In one embodiment, the touch panel 2 displays the virtual keyboard on a display of the touch panel 2 to receive the contact input. An example shown in FIG. 3, the virtual keyboard is displayed on a display of the touch panel 2. In other embodiments, the touch panel 2 can be a resistive or capacitive touch screen.

The memory 11 is electronically connected to the touch panel 2, the at least one processor 12, the accelerometer 13, the control module 101, the calculation module 102 and the adjustment module 103. The memory 11 is operable to store many kinds of data, such as a customized function code of the portable electronic device 1, programs of an operating system and other applications of the portable electronic device 1. The memory 11 may include a hard disk drive, flash memory, RAM, ROM, cache, or external storage media.

The modules 101-103 may comprise computerized code in the form of one or more programs stored in the memory 11. The computerized code includes instructions executed by the at least one processor 12 to provide functions for modules 101-103. The at least one processor 12, as an example, may include a CPU, math coprocessor, or shift register, for example.

The accelerometer 13 is operable to detect three component vectors of acceleration along three coordinate axes of the portable electronic device 1. In one embodiment, the accelerometer 13 starts to detect acceleration when the virtual keyboard is displayed on the display of the touch panel 2.

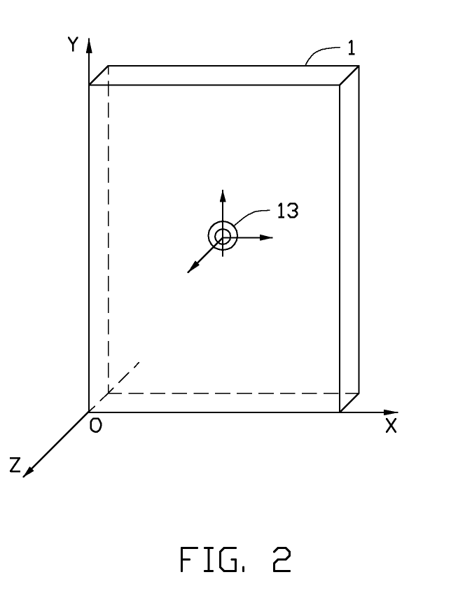

As shown in FIG. 2, a schematic diagram of the accelerometer 13 of the portable electronic device 1 positioned at the three coordinate axes is shown. The portable electronic device 1 is positioned at a space coordinate OXYZ. The space coordinate OXYZ comprises axes OX, OY and OZ. In one embodiment, the touch panel 2 is positioned on a plane XOY. The accelerometer 13 is installed in a specific position in which its own three coordinate axes are parallel to the axes OX, OY and OZ. The accelerometer 13 can immediately detect changing orientation of the portable electronic device 1 by the specific position.

In other embodiments, the portable electronic device 1 can be vertically positioned at the coordinate OXYZ. The accelerometer 13 can detect the three component vectors of acceleration (0, −g, 0) along the axes OX, OY and OZ. Accordingly, the component vector of acceleration along the axis OY is −g m/sec². A negative value of the component vector (−g m/sec²) indicates acceleration in a direction opposite to the axis OY.

The control module 101 is operable to direct the accelerometer 13 to detect the three component vectors of gravity along the three coordinate axes. In one embodiment, the virtual keyboard is displayed on the display of the touch panel 2 when the user touches the touch panel 2 of the portable electronic device 1. The control module 101 controls the accelerometer 13 to detect acceleration of the portable electronic device 1 upon detecting that the virtual keyboard is displayed on the display of the touch panel 2.

The calculation module 102 is operable to calculate the orientation of the portable electronic device 1 by the three component vectors of gravity along the three coordinate axes detected from the accelerometer 13. In one embodiment, the accelerometer 13 detects the component vector of acceleration along the axis OX between 0 and g m/sec² (not includes g m/sec²). A positive value of the component vector of acceleration along the axis OX represents that the axis OX is oriented in the direction of acceleration. It can represent the portable electronic device 1 is oriented to a rightwards direction (the axis OX direction). Otherwise, a negative value of the component vector of acceleration along the axis OX represents that the axis OX is oriented to the opposite direction of acceleration. It can represent the portable electronic device 1 is oriented to a leftwards direction (opposite direction of the axis OX).

In other embodiments, the accelerometer 13 detects the component vector of acceleration along the axis OZ between −g and 0 m/sec² (not includes −g m/sec²). The negative value of the component vector of acceleration along the axis OZ represents that the axis OZ is oriented to the opposite direction of acceleration. It indicates that the portable electronic device 1 is oriented to an upwards direction (opposite direction of the axis OZ). Otherwise, the positive value of the component vector of acceleration along the axis OZ represents that the axis OZ is oriented to the direction of acceleration. It represents the portable electronic device 1 is oriented to a downwards direction (direction of the axis OZ).

The adjustment module 103 is operable to adjust the display of each key of the virtual keyboard according to the orientation of the portable electronic device 1 received from the calculation module 102. In one embodiment, if the orientation of the portable electronic device 1 received from the calculation module 102 is oriented in the right direction, the adjustment module 103 shifts the contact area of each key of the virtual keyboard in the left direction in a predetermined distance, by, for example, a one or two pixel distance. The different predetermined distance is preset by different sizes of each key of the virtual keyboard. The different predetermined distance is then saved in the memory 12.

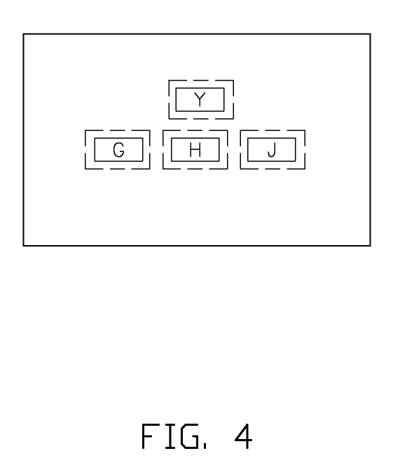

As shown in FIG. 4, a schematic diagram of parts of keys of the virtual keyboard of the touch panel 2 of the portable electronic device 1 is displayed. Each dotted border of each key indicates the contact area of each key of the virtual keyboard. The solid border of each key indicates a display area of each key of the virtual keyboard. If at least one of the areas of dotted border is contacted, the corresponding key is registered. In one embodiment, the adjustment module 103 can adjust the dotted border of each key (contact area) upon detecting the orientation of the portable electronic device 1 from the calculation module 102.

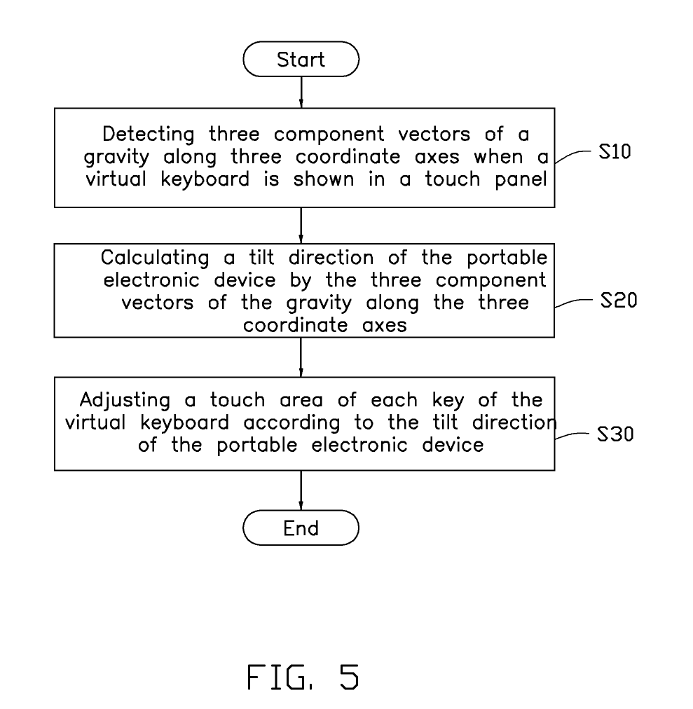

FIG. 5 is a flowchart of one embodiment of a method of detecting contact for a portable electronic device 1. Depending on the embodiment, additional blocks may be added, others deleted, and the ordering of the blocks may be changed.

In block S10, the accelerometer 13 detects three component vectors of acceleration along three coordinate axes of the portable electronic device 1 when a virtual keyboard is displayed on a display of the touch panel 2.

In block S20, the calculation module 102 calculates an orientation of the portable electronic device 1 by the three component vectors of gravity along the three coordinate axes detected from the accelerometer 13.

In block S30, the adjustment module 103 adjusts a contact area of each key of the virtual keyboard displayed on the display of the touch panel 2 according to the orientation of the portable electronic device 1. In one embodiment, the adjustment module 103 shifts the contact area of each key in the left direction corresponding to an original contact area if the calculation module 102 calculates the portable electronic device 1 is oriented to the rightwards direction. The adjustment module 103 further shifts the contact area of each key in the right direction corresponding to the original contact area if the calculation module 102 calculates the portable electronic device 1 is oriented to the leftwards direction.

In other embodiments, the adjustment module 103 shifts the contact area of each key in the upward direction corresponding to the original contact area if the calculation module 102 calculates the portable electronic device 1 is oriented to the downwards direction. The adjustment module 103 further shifts the contact area of each key in the downward direction corresponding to the original contact area if the calculation module 102 calculates the portable electronic device 1 is oriented to the upwards direction.

Although certain embodiments of the present disclosure have been specifically described, the present disclosure is not to be construed as limited thereto. Various changes or modifications may be made to the present disclosure without departing from the scope and spirit of the present disclosure.

What is claimed is:

1. A portable electronic device, comprising:
a memory;
a touch panel;
at least one processor;
an accelerometer;
one or more programs stored in the memory and executed by the at least one processor, the one or more programs comprising:
a control module operable to direct the accelerometer to detect three component vectors of acceleration along three coordinate axes of the portable electronic device when a virtual keyboard is displayed on a display of the touch panel;
a calculation module operable to calculate an orientation of the portable electronic device according to the three component vectors of gravity along the three coordinate axes; and
an adjustment module operable to adjust a contact area of each key of the virtual keyboard according to the orientation.

2. The portable electronic device of claim 1, wherein the touch panel is a capacitive panel.

3. The portable electronic device of claim 1, wherein the touch panel is a resistive touch panel.

4. The portable electronic device of claim 1, wherein the portable electronic device is a mobile phone, a digital camera, a multimedia player or a PDA.

5. The portable electronic device of claim 1, wherein the portable electronic device is a tablet computer.

6. A method of a portable electronic device, the portable electronic device comprising an accelerometer, a memory, a touch panel and at least one processor, the method comprising:
detecting three component vectors of acceleration along three coordinate axes of the portable electronic device by the accelerometer when a virtual keyboard is displayed on a display of the touch panel;
calculating an orientation of the portable electronic device according to the three coordinate axes of the portable electronic device; and
adjusting a contact area of each key of the virtual keyboard according to the orientation.

7. The method of claim 6, wherein adjustment of the contact area of each key of the virtual keyboard comprises shifting the contact area of each key a predetermined distance corresponding to an original contact area when the orientation of the portable electronic device is detected.

8. The method of claim 7, wherein adjustment of the contact area of each key of the virtual keyboard comprises shifting the contact area of each key in a left direction corresponding to an original contact area upon detecting that the portable electronic device is oriented in a rightwards direction.

9. The method of claim 7, wherein adjustment of the contact area of each key of the virtual keyboard comprises shifting the contact area of each key in a right direction corresponding to an original contact area upon detecting that the portable electronic device is oriented in a leftwards direction.

10. The method of claim 7, wherein adjustment of the contact area of each key of the virtual keyboard comprises shifting the contact area of each key in an upward direction corresponding to an original contact area upon detecting that the portable electronic device is oriented in a downwards direction.

11. The method of claim 7, wherein adjustment of the contact area of each key of the virtual keyboard comprises shifting the contact area of each key in a downward direction corresponding to an original contact area upon detecting that the portable electronic device is oriented in a upwards direction.

12. A storage medium having stored thereon instructions that, when executed by a processor, causes the processor to perform a method of a portable electronic device, the portable electronic device comprising an accelerometer, a memory, a touch panel and at least one processor, the method comprising:
detecting three component vectors of acceleration along three coordinate axes of the portable electronic device by the accelerometer when a virtual keyboard is displayed on a display of the touch panel;
calculating an orientation of the portable electronic device according to the three coordinate axes of the portable electronic device; and
adjusting a contact area of each key of the virtual keyboard according to the orientation.

13. The storage medium of claim 12, wherein adjustment of the contact area of each key of the virtual keyboard comprises shifting the contact area of each key a predetermined distance corresponding to an original contact area when the orientation of the portable electronic device is detected.

14. The storage medium of claim 12, wherein adjustment of the contact area of each key of the virtual keyboard comprises shifting the contact area of each key in a left direction corresponding to an original contact area upon detecting that the portable electronic device is oriented in a rightwards direction.

15. The storage medium of claim 12, wherein adjustment of the contact area of each key of the virtual keyboard comprises shifting the contact area of each key in a right direction corresponding to an original contact area upon detecting that the portable electronic device is oriented in a leftwards direction.

16. The storage medium of claim 12, wherein adjustment of the contact area of each key of the virtual keyboard comprises shifting the contact area of each key in an upward direction corresponding to an original contact area upon detecting that the portable electronic device is oriented in a downwards direction.

17. The storage medium of claim 12, wherein adjustment of the contact area of each key of the virtual keyboard comprises shifting the contact area of each key in a downward direction corresponding to an original contact area upon detecting that the portable electronic device is oriented in a upwards direction.
